(19) United States
(12) Patent Application Publication
(10) Pub. No.: US 2011/0222077 A1
(43) Pub. Date: Sep. 15, 2011

(54) IMAGE FORMING APPARATUS AND DENSITY UNEVENNESS CORRECTION METHOD

(75) Inventor: Daisuke GENDA, Kawasaki-shi (JP)

(73) Assignee: KONICA MINOLTA BUSINESS TECHNOLOGIES, INC., Tokyo (JP)

(21) Appl. No.: 13/044,650

(22) Filed: Mar. 10, 2011

(30) Foreign Application Priority Data
Mar. 11, 2010 (JP) 2010-053905

(51) Int. Cl. G06K 15/02

(52) U.S. Cl. 358/1.2

(57) ABSTRACT

Disclosed is an image forming apparatus including: an image forming section to write a latent image, and to develop the latent image to form an image; a misalignment detecting section to detect misalignment amount of a sheet in the main scanning direction on a sheet conveying path to the image forming section; a storage section to store the misalignment amount; a density measuring section to measure density of a plurality of preset positions and to generate measurement data; and a control section to adjust a writing position on the image carrier; to allow the image forming section to output the sheet on which a density measuring image is formed; and to convert the position on the sheet of the measurement data to the writing position on the image carrier and to generate correction data; and a density unevenness correcting section to correct the density of the image.

### BACKGROUND

1. Field of the Invention

The present invention relates to an image forming apparatus and a density unevenness correction method.

2. Description of Related Art

Lately, in an image forming apparatus of an electro-photographic method, an electrostatic latent image is formed on an image carrier such as a photoconductor drum in which an exposed surface rotates at a constant cycle, a toner image is formed by applying toner to the electrostatic latent image, the toner image is transferred onto a sheet by a transferring device and with this, an image is formed on a sheet.

In such image forming apparatus, there is a problem that distortion of an optical system of an exposing device which forms the electrostatic latent image, installation error between the photoconductor drum and the developer which applies toner, etc. causes density unevenness in a main scanning direction of an image formed on a sheet and quality of the image decreases. Therefore, density unevenness in the main scanning direction is detected and correction of the density unevenness is performed based on the detected result.

For example, Japanese Patent Application Laid-Open Publication No. 2002-49189 discloses an image forming apparatus which forms an image pattern of a density pattern in which the density in a main scanning direction is the same and the density in a sub scanning direction changes gradually and a mark indicating an image center position of the image pattern on a transfer sheet; reads the image pattern formed on the transfer sheet; sets an image density of the mark indicating the image center position of the read image pattern as a standard density; compares the standard density with the image density in the main scanning direction of the read image pattern; and corrects writing light intensity of an image writing section so that an image density of a position different from the standard position is the same as the standard density, in order to correct density unevenness in the main scanning direction.

When density unevenness correction is performed in the main scanning direction, in order to enhance accuracy of correction of density unevenness in the main scanning direction, a length in the main scanning direction of the image in which density unevenness is measured (density unevenness measuring image) and a length of the main scanning direction of a sheet on which the density unevenness measuring image is formed needs to be substantially the same length. However, there is a problem that when the position of the main scanning direction of the sheet is misaligned in one direction during conveying of the sheet on the conveying path, the center position of the main scanning direction of the density unevenness measuring image does not match the center position of the main scanning direction of the sheet, and as a result the density unevenness measuring image goes outside the image forming area of the sheet.

Therefore, misalignment correction is performed to move the writing position of the image in the main scanning direction in the misaligned amount of the sheet. It is possible to form on the sheet a density unevenness measuring image with substantially the same length as the length of the main scanning direction of the sheet by performing the misalignment correction.

The correction data of the density unevenness is generated corresponding to the writing position with respect to the image carrier whereas the measurement data measured from the density unevenness measuring image corresponds to a position on the sheet on which the density unevenness measuring image is formed. Therefore, the position of the measurement data is converted to a preset writing position of the image carrier.

However, there is a problem that when misalignment correction is performed, since the center position of the writing position when the density unevenness measuring image is formed does not match with the center position of the writing position of the image carrier, the data is not suitable as measurement data when correction data is generated, the accuracy of correction using the correction data decreases and density unevenness cannot be solved.

### SUMMARY

The present invention has been made in consideration of the above problems, and it is one of main objects to prevent reduction of accuracy of density unevenness correction, even when misalignment correction of the sheet in the main scanning direction is performed.

In order to achieve at least one of the above-described objects, according to an aspect of the present invention, there is provided an image forming apparatus including:

an image forming section to write a latent image based on image data on an image carrier extending in a main scanning direction which is a direction orthogonal to a conveying direction of a sheet, and to develop the latent image to form an image on a sheet;

a misalignment detecting section to detect misalignment amount of a sheet in the main scanning direction on a sheet conveying path to the image forming section;

a storage section to store the misalignment amount detected by the misalignment detecting section;

a density measuring section to measure density of a plurality of preset positions in the main scanning direction of the image formed on the sheet and to generate measurement data; and

a control section
to adjust a writing position in the main scanning direction on the image carrier of the latent image based on the misalignment amount;
to allow the image forming section to write on the image carrier the latent image based on image data in which density is the same in the main scanning direction and to develop the latent image to output the sheet on which a density measuring image is formed; and
to convert the position in the main scanning direction on the sheet of the measurement data obtained from the density measuring section to the writing position in the main scanning direction on the image carrier according to the misalignment amount stored in the storage section and to generate correction data to correct density unevenness in the main scanning direction based on measurement data in which the position in the main scanning direction is converted; and

a density unevenness correcting section to correct the density of the image formed by the image forming section based on the correction data generated by the control section.

According to another aspect of the present invention, there is provided an image forming apparatus including:

an image forming section to write a latent image based on image data on an image carrier extending in a main scanning direction which is a direction orthogonal to a conveying direction of a sheet, and to develop the latent image to form an image on a sheet which is output;

a misalignment detecting section to detect misalignment amount of a sheet in the main scanning direction on a sheet conveying path to the image forming section;

a density measuring section to measure density of a plurality of preset positions in the main scanning direction of the image formed on the sheet and to generate measurement data;

an input section to receive input of the misalignment amount; and

a control section
to adjust a writing position in the main scanning direction on the image carrier of the latent image based on the misalignment amount;
to allow the image forming section to write on the image carrier the latent image based on image data in which density is the same in the main scanning direction and image data indicating the misalignment amount and to develop the latent image to output the sheet on which a density measuring image and a misalignment amount image is formed;
to receive input of the misalignment amount indicated by the misalignment amount image formed on the sheet from the input section;
to convert the position in the main scanning direction on the sheet of the measurement data obtained from the density measuring section to the writing position in the main scanning direction on the image carrier according to the misalignment amount received from the input section and to generate correction data to correct density unevenness in the main scanning direction based on measurement data in which the position in the main scanning direction is converted; and
a density unevenness correcting section to correct the density of the image formed by the image forming section based on the correction data generated by the control section.

According to another aspect of the present invention, there is provided a density unevenness correction method comprising:

misalignment detecting to detect misalignment amount of a sheet in a main scanning direction which is a direction orthogonal to a sheet conveying direction on a sheet conveying path;

storing to store the detected misalignment amount in a storage section;

sheet outputting to write a latent image based on image data with a same density in the main scanning direction on an image carrier extending in the main scanning direction and to develop the latent image to output a sheet on which a density measuring image is formed;

misalignment amount correcting to adjust a writing position of the latent image in the main scanning direction on the image carrier based on the misalignment amount;

density measuring to measure density in a plurality of preset positions in the main scanning direction of the density measuring image formed on the sheet to generate measurement data;

correction data generating to convert the position in the main scanning direction on the sheet of the measurement data generated in the density measuring step to the writing position in the main scanning direction on the image carrier according to the misalignment amount stored in the storage section and to generate correction data to correct density unevenness in the main scanning direction based on the measurement data on which the position in the main scanning direction is converted; and

density unevenness correcting to correct density of an image formed on the sheet based on the generated correction data.

According to another aspect of the present invention, there is provided a density unevenness correction method including:

misalignment detecting to detect a misalignment amount of a sheet in a main scanning direction which is a direction orthogonal to a sheet conveying direction on a sheet conveying path;

sheet outputting to write a latent image based on image data with a same density in the main scanning direction and image data indicating the misalignment amount on an image carrier extending in the main scanning direction and to develop the latent image to output a sheet on which a density measuring image and a misalignment amount image is formed;

misalignment amount correcting to adjust a writing position of the latent image in the main scanning direction on the image carrier based on the misalignment amount;

density measuring to measure density in a plurality of preset positions in the main scanning direction of the density measuring image formed on the sheet to generate measurement data;

inputting to receive input of a misalignment amount indicated by the misalignment amount image formed on the sheet;

correction data generating to convert the position in the main scanning direction on the sheet of the measurement data generated in the density measuring step to the writing position in the main scanning direction on the image carrier according to the misalignment amount received in the inputting step and to generate correction data to correct density unevenness in the main scanning direction based on the measurement data on which the position in the main scanning direction is converted; and

density unevenness correcting to correct density of an image formed on the sheet based on the generated correction data.

### BRIEF DESCRIPTION OF THE DRAWINGS

The present invention will become more fully understood from the detailed description given hereinbelow and the appended drawings, and thus are not intended to define the limits of the present invention, and wherein;

FIG. 1 is a schematic configuration diagram of an image forming apparatus of embodiment 1;

FIG. 2 is a diagram showing an example of a density unevenness measuring chart of embodiment 1;

FIG. 3A is a diagram schematically showing a relation of a position between a misalignment detecting section and a sheet;

FIG. 3B is a diagram schematically showing an A-A cross-section of the misalignment detecting section;

FIG. 4 is a flowchart showing density unevenness measuring chart output processing of embodiment 1;

FIG. 5 is a flowchart showing density unevenness correction data generation processing of embodiment 1;

FIG. 6A is a diagram showing an example of a relation between a position in a main scanning direction on a sheet which is a density unevenness correcting chart and a writing position in a main scanning direction on a photoconductor drum when the position of the sheet is aligned in the main scanning direction;

FIG. 6B is a diagram showing an example of a relation between a position in a main scanning direction on a sheet which is a density unevenness correcting chart and a writing position in a main scanning direction on a photoconductor drum when the position of the sheet is misaligned in the main scanning direction;

FIG. 7A is a diagram showing an example of transition of position of measurement data in steps S14 and S15 when the position of the sheet is aligned in the main scanning direction;

FIG. 7B is a diagram showing an example of transition of position of measurement data in steps S14 and S15 when the position of the sheet is misaligned in the main scanning direction;

FIG. 8 is a diagram showing an example of a density unevenness measuring chart of embodiment 2;

FIG. 9 is a flowchart of density unevenness measuring chart output processing of embodiment 2; and

FIG. 10 is a flowchart of density unevenness correction data generation processing of embodiment 2.

### DETAILED DESCRIPTION OF PREFERRED EMBODIMENTS

### Embodiment 1

Below, embodiment 1 is described in detail with reference to the drawings.

First, the configuration is described.

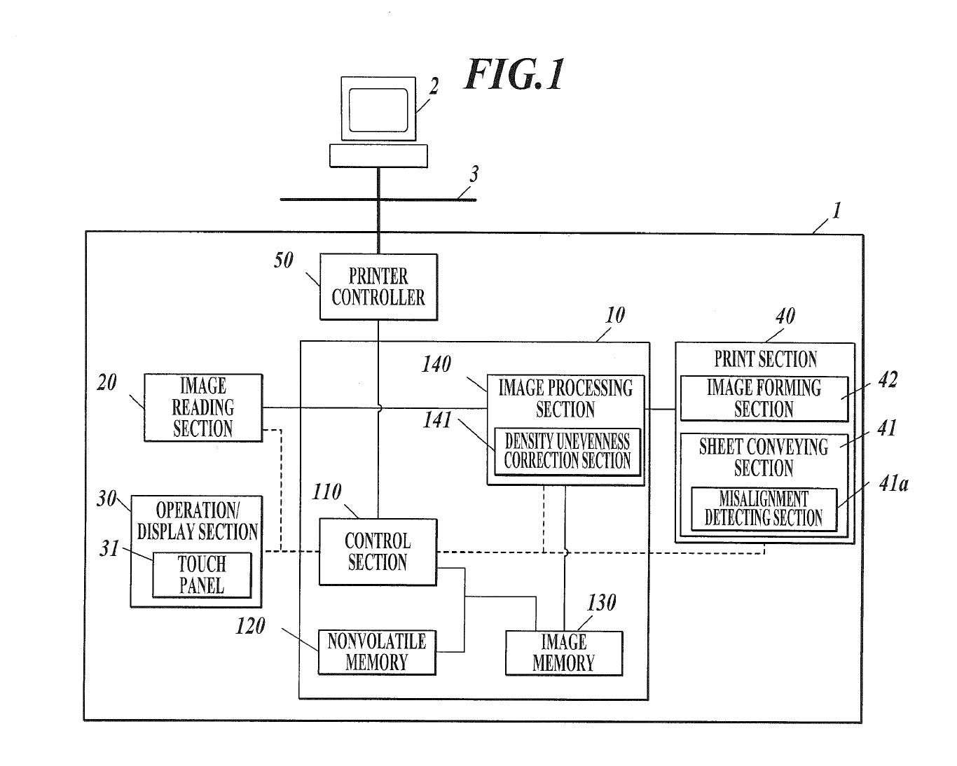

FIG. 1 is a diagram showing a schematic configuration of an image forming apparatus 1 in embodiment 1.

As shown in FIG. 1, the image forming apparatus 1 is configured including a main body control section 10, an image reading section 20, an operation/display section 30, a print section 40, a printer controller 50 and the like.

The main body control section 10 includes a control section 110, a nonvolatile memory 120, an image memory 130, an image processing section 140 and the like, and each section is controlled by the control section 110.

The control section 110 includes a CPU (Central Processing Unit), a ROM (Read Only Memory), a RAM (Random Access Memory), etc. The control section 110 reads out a program or data specified from a system program and various application programs, and various pieces of data stored in the ROM, the nonvolatile memory 120, or the DB 122 and expands the program in the RAM. In coordination with the program expanded in the RAM, the control section 110 performs various processing and centrally controls each section of the image forming apparatus 1. For example, according to an instruction signal input from the operation/display section 30 or an external apparatus 2 connected through the printer controller 50, the control section 110 performs control of switching between copying mode, printer mode and scanning mode, copying, printing, reading of image data, etc.

Moreover, the control section 110 reads out a misalignment correction processing program, a density unevenness measuring chart output processing program, a density unevenness correction data generation processing program and various necessary pieces of data from the ROM or the nonvolatile memory 120, and in coordination with the program and various pieces of data, the control section 110 performs misalignment correction processing, density unevenness measuring chart output processing and density unevenness correction data generation processing.

The misalignment correction processing is a processing which adjusts a writing position of a latent image in the main scanning direction on an image carrier (photoconductor drum) based on a misaligned amount detected from a misalignment sensor provided on a sheet conveying path in the print section 40. Therefore, the control section 110 functions as a misalignment correction section.

In the density unevenness measuring chart output processing in embodiment 1, a length of a main scanning direction which is a direction orthogonal to a sheet conveying direction when the sheet is conveyed on the sheet conveying path based on the sheet size of the sheet stored in the sheet feeding tray selected on the operation/display section 30 is obtained. Then, density unevenness measuring image data in a length in the main scanning direction according to the obtained length of the main scanning direction is generated. The latent image based on the generated density unevenness measuring image data is written on the photoconductor drum and the latent image is developed to output a sheet on which a density measuring image (density unevenness measuring chart) is formed.

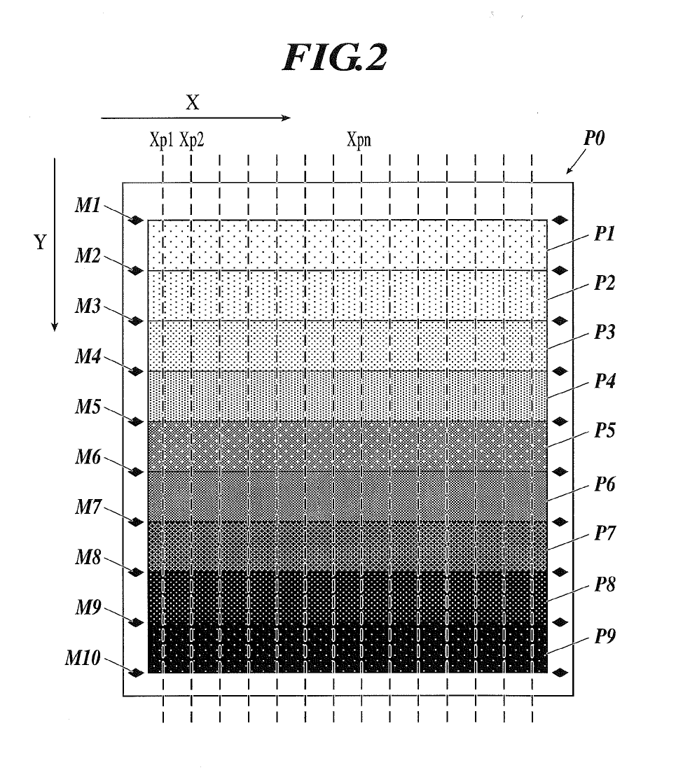

FIG. 2 is a diagram showing an example of a density unevenness measuring chart of embodiment 1.

As shown in FIG. 2, the density unevenness measuring chart P0 includes a density measuring image composed of a plurality of bar shaped images P1 to P9 extending in the main scanning direction X with a preset density. The bar shaped images P1 to P9 are each an image with a density different from the bar shaped image adjacent in the sheet conveying direction (sub scanning direction Y), and the bar shaped images are arranged so that the density of each bar shaped image gradually becomes darker or lighter in the direction from the beginning edge of the sheet towards the end edge of the sheet in the sub scanning direction Y.

FIG. 2 shows an example of a density unevenness measuring chart which is formed by one toner color of the image forming section included in the print section 40. However, the image is not limited to this, and it is preferable to form the density measuring image for each toner color included in the image forming section.

Moreover, in the density unevenness measuring chart P0, marks M1 to M10 indicating a position of a sub scanning direction of each bar shaped image are provided on both edge sections in the main scanning direction of the bar shaped image. The plurality of broken lines shown in FIG. 2 which are placed at a certain interval in the main scanning direction X show a position where the density in the main scanning direction of each bar shaped image is measured by the image reading section 20 or a measuring instrument.

In the density unevenness correction data generation processing of embodiment 1, measurement data showing density of each position in the main scanning direction of each bar shaped image of the density measuring image formed on the density unevenness measuring chart is obtained from the image reading section or the measuring instrument. Then, the misalignment amount when the density unevenness measuring chart is output is read out from the nonvolatile memory 120. The position in the main scanning direction on the sheet of the measurement data is converted to the writing position in the main scanning direction on the photoconductor drum according to the misalignment amount. Then, the correction data to correct the density unevenness in the main scanning direction is generated based on the measurement data in which the position in the main scanning direction is converted.

The nonvolatile memory 120 stores not only various processing programs and various pieces of data regarding image forming but also the misalignment correction processing program, density unevenness measuring chart output processing program and density unevenness correction data generation processing program of embodiment 1, data generated and processed by performing the various programs, and the like.

Moreover, the nonvolatile memory 120 functions as a storage section to store misalignment amount detected from a misalignment detecting section 41a.

The image memory 130 includes a HDD (Hard Disk Drive), a DRAM (Dynamic RAM) and the like, and stores image data in a readable and writable form. According to an instruction from the control section 110, the image memory 130 stores image data input from an image reading section 20 or printer controller 50, and reads out image data stored in the image memory 130 and outputs the read out image data to the image processing section 140.

The image processing section 140 performs various image processing such as screen processing, etc. on the image data input from the image reading section 20, printer controller 50 or the image memory 130 and outputs the image data to the image memory 130. For example, the image processing section 140 converts an analog image signal input from the image reading section 20 to digital image data, compresses the digital image data to output the image data to the image memory 130, and expands the compressed image data to output the data as print data.

Further, the image processing section 140 includes a density unevenness correction section 141.

The density unevenness correction section 141 corrects density of each pixel in the main scanning direction with respect to each toner color included in the image forming section based on the correction data input from the control section 110.

Moreover, according to a main scanning writing standard signal (INDEX signal) output from the image forming section 42 and an instruction from the control section 110, the image processing section 140 generates a main scanning valid writing signal (HV signal; Horizontal Valid Signal) and sub scanning valid writing signal (VV signal; Vertical Valid signal), clock signal, etc. and outputs the signal to the image forming section 42.

The INDEX signal is a timing signal generated when a laser of an exposure device passes a sensor provided near a scanning starting position in a main scanning direction when scanning in a main scanning direction, and the time from the timing of when the INDEX signal rises to the timing of when the next INDEX signal rises (main scanning writing standard term) is a certain amount of time.

The HV signal is generated based on the length of the main scanning direction of the size of the sheet and from when the HV signal rises (High) (HS) to when the HV signal falls (Low) (HE) shows the valid area of one line in the main scanning direction.

The image reading section 20 includes a CCD, an image reading control section, an automatic document feeding section called an ADF (Auto Document Feeder), reading section, and the like. The image reading control section includes a scanner function in which the image reading control section controls the automatic document feeding section, reading section, etc. according to an instruction from the control section 110, and reads the image of a plurality of documents. The read image data is output to the image processing section 140. Here, the image is not limited to image data such as graphics, photographs, etc., and includes text data, etc. such as characters, symbols, etc.

Moreover, the image reading section 20 of embodiment 1 reads a density unevenness measuring chart using a scanner function, measures the density of each position in the main scanning section of each bar shaped image formed on the density unevenness measuring chart and functions as a density measuring section to generate measurement data.

A structure in which measurement data is generated by reading the density unevenness measuring chart using a measuring instrument dedicated to reading the density unevenness measuring chart and the generated measurement data is output to the control section 110 can be employed as the density measuring section.

The measuring instrument is composed including a CCD camera and a density meter such as an optical transmission density meter. The measuring instrument measures the density of each position in the main scanning direction of each bar shaped image of the density unevenness measuring test chart with the CCD camera and density meter and generates measurement data. The measuring instrument can be portable or can be provided in the image forming apparatus 1 in advance.

The operation/display section 30 is composed from a display section including a LCD (Liquid Crystal Display), etc. and a touch panel 31 provided covering the LCD, and as other components, an input section such as operation keys, and an operation/display control section which are not shown. The operation/display section 30 outputs an operation signal input from a touch panel 31 or input section such as operation keys to the control section 110. Moreover, the operation/display section 30 displays various screens to input various setting conditions, various processing results, etc. on the display section according to a display signal input from the control section 110 by the operation display control section.

The print section 40 performs image forming processing by electro-photography based on input print data and is composed including sections regarding printed output such as a sheet feeding section, a sheet conveying section 41, image forming section 42 of each color, a fixing section, an ejecting section, etc. and a print control section.

The sheet feeding section includes a plurality of sheet feeding trays. Each sheet feeding tray stores sheets distinguished in advance according to type of sheet (sheet type, basis weight, sheet size, etc.) and the sheet is conveyed to the sheet conveying section 41 from the top one sheet at a time.

The sheet conveying section 41 conveys the sheet conveyed from the sheet feeding tray on a sheet feeding path to the image forming section 42 which passes through a plurality of intermediate rollers, registration rollers, etc. and conveys the sheet to the transfer device of the image forming section 42.

The misalignment detecting section 41a for detecting a misalignment amount of the sheet in a direction (main scanning direction) orthogonal to a sheet conveying direction is provided on the sheet conveying path of the sheet conveying section 41.

The misalignment detecting section 41a includes a light emitting section composed of a plurality of light emitting diode arranged in the main scanning direction and a light receiving section including a line CCD extending in the main scanning direction. The misalignment detecting section 41a detects a distance (misalignment amount) between the position of the sheet and the preset position in the direction orthogonal to the sheet conveying direction.

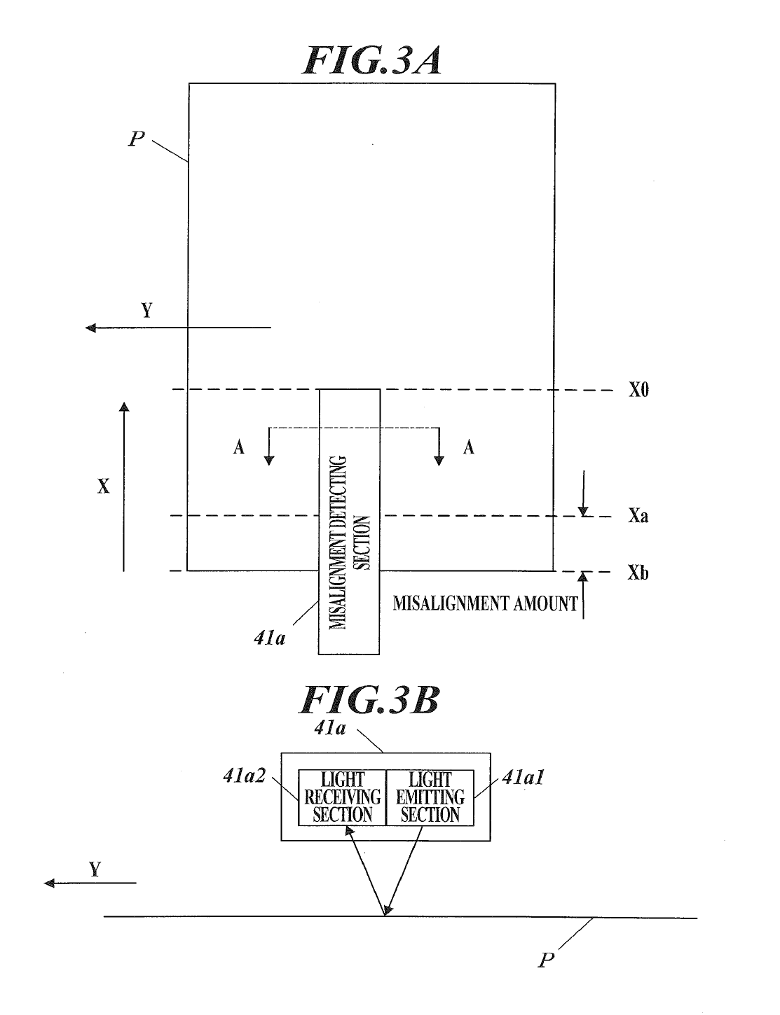

FIG. 3A is a diagram schematically showing a relation of a position between the misalignment detecting section 41a and the sheet P, and FIG. 3B is a diagram schematically showing a cross section A-A of a misalignment detecting section 41a.

As shown in FIG. 3A, the misalignment detecting section 41A is provided extending in a direction (main scanning direction X) orthogonal to a sheet conveying direction (sub scanning direction Y) and is provided in a position where the sheet P passes below the misalignment detecting section 41a. Moreover, as shown in FIG. 3B, the misalignment detecting section 41a includes a light emitting section 41a1 and a light receiving section 41a2. The light emitted from the light emitting section 41a1 is reflected by the sheet P. Then, the light receiving section 41a2 receives the reflected light and the misalignment detecting section 41a detects whether or not the sheet P passed below the misalignment detecting section 41a.

As shown in FIG. 3A, one edge of the misalignment detecting section 41a is set as the misalignment sensor origin X0, and a proper position Xa of one edge of the sheet in the direction (main scanning direction X) orthogonal to the sheet conveying direction is determined according to the length in the main scanning direction of the sheet P. Since the misalignment detecting section 41a can detect a position where the sheet P passed, the misalignment detecting section 41a can detect one edge of the sheet P which passed. The misalignment detecting section 41a calculates a distance between the position Xb of one edge of the sheet P and the proper position Xa and outputs the calculated distance as the misalignment amount to the control section 110.

The image forming section 42 includes a photoconductor drum as an image carrier extending in the main scanning direction which is a direction orthogonal to the conveying direction of the sheet, a charging device, an exposure device, a developing device, a first transfer roller, a cleaning device, etc. and generated output product in which an image is formed on a sheet based on image data included in the job data. The image forming section 42 is provided for each color when the image forming apparatus 1 forms a color image.

In the image forming section 42 which forms an image of the color yellow (Y), light according to image data of yellow (Y) is emitted from the exposure device and an electrostatic latent image is written on a surface of the photoconductor drum charged by the charging device. Then, charged yellow (Y) toner is applied by the developing device onto the surface of the photoconductor drum on which the electrostatic latent image is written and the electrostatic latent image is developed. The toner which is applied onto the photoconductor drum by the developing device is transferred to the intermediate transfer belt at a position of a first transfer where the first transfer roller is positioned by the photoconductor drum rotating at a certain speed. After the toner is transferred onto the intermediate transfer belt, the cleaning device removes residual charge, residual toner, etc. on the surface of the photoconductor drum.

Similarly, the image forming section 42 of each color includes a charging device, an exposure device, a developing device, a first transfer roller and a cleaning device positioned around the photoconductor drum, and forms toner images of each color of magenta (M), cyan (C) and black (K).

The toner images of each color transferred onto the intermediate transfer belt are collectively transferred on a sheet at a position of a second transfer where a second transfer roller is positioned.

The fixing device heat fixes the toner image transferred onto the sheet. The ejecting section holds the sheet on which fixing processing is performed between sheet ejecting rollers, etc. and ejects the sheet on a sheet ejecting tray.

The printer controller 50 performs management and control of a job transmitted to the image forming apparatus 1 from the external apparatus 2 such as a PC (Personal Computer) connected to the network 3 such as a LAN (Local Area Network) when the image forming apparatus 1 is used as a network printer. The printer controller 50 receives data to be printed from the external apparatus 2 and outputs the data as job data to the control section 110.

Next, the operation of embodiment 1 is described.

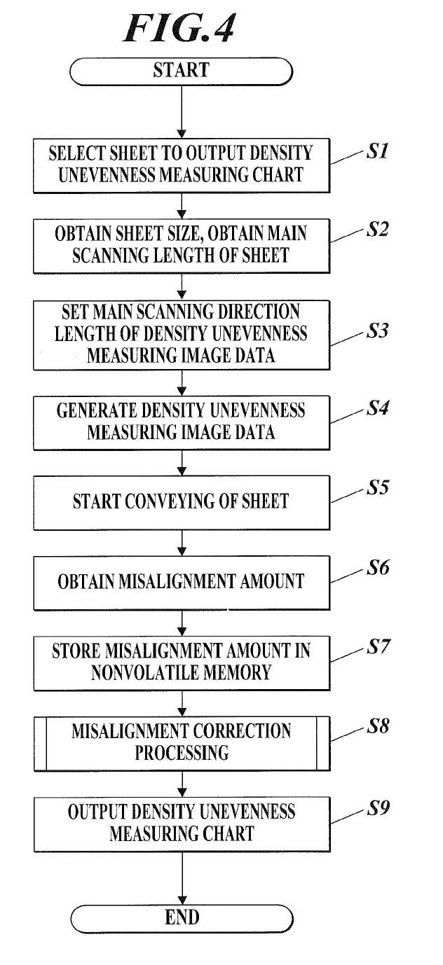

FIG. 4 is a diagram showing a flowchart of density unevenness measuring chart output processing in embodiment 1. The flowchart shown in FIG. 4 is processing performed by the control section 110 in coordination with each section.

When an instruction to output the density unevenness measuring chart is input from the operation/display section 30 and an instruction selecting a sheet feeding tray in which the sheet to be output as the density unevenness measuring chart is stored is input (step S1), the control section 110 obtains the sheet size of the sheet which is stored in the selected sheet feeding tray, and a length (main scanning length) in the direction orthogonal to the conveying direction of the sheet is obtained according to the obtained sheet size (step S2).

The control section 110 sets the main scanning length of the sheet obtained in step S2 as the length in the main scanning direction of the density unevenness measuring image data, in other words, the length in the main scanning direction of each bar shaped image (step S3), and density unevenness measuring image data in which the length in the main scanning direction is the length set in step S3 is generated (step S4).

The control section 110 allows the sheet conveying section 41 to start conveying of the sheet stored in the sheet tray selected in step S1 (step S5), obtains the misalignment amount of the conveyed sheet from the misalignment detecting section 41a (step S6) and stores the obtained misalignment amount in the nonvolatile memory 120 (step S7).

When the misalignment amount is obtained, the control section 110 performs the misalignment correction processing (step S8). In step S8, the time from when the INDEX signal rises to when the HV signal rises is adjusted based on the misalignment amount and the writing position of the latent image in the main scanning direction on the photoconductor drum is adjusted based on the density unevenness measuring image data.

According to the HV signal, etc., the control section 110 forms the density measuring image on the sheet based on the density unevenness measuring image data, outputs the density unevenness measuring chart from the print section (step S9), and ends the density unevenness measuring chart output processing.

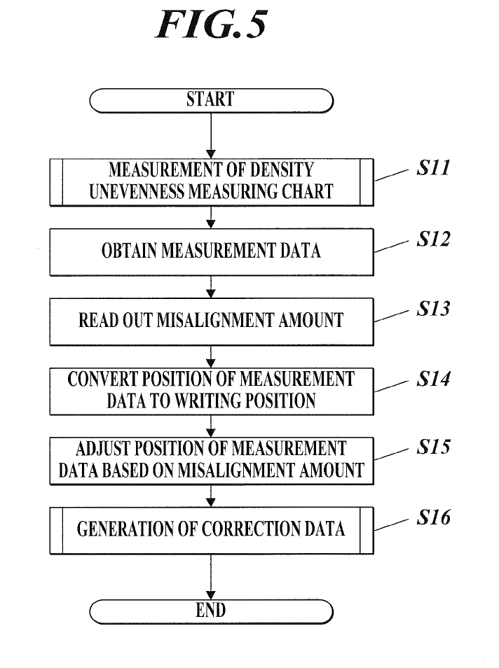

FIG. 5 is a diagram showing a flowchart of the density unevenness correction data generation processing of embodiment 1. The flowchart shown in FIG. 5 is a processing performed by the control section 110 in coordination with each section.

First, the measurement of the density unevenness measuring chart output in the density unevenness measuring chart output processing is performed (step S11).

In step S11, the density value of each color and each bar shaped image is measured with respect to each preset position in the main scanning direction of the density unevenness measuring chart by the image reading section 20 or the measuring device and the measurement data is generated.

The control section 110 obtains measurement data generated in step S11 from the image reading section 20 or the measuring device (step S12). Moreover, the control section 110 reads out the misalignment amount when the density unevenness measuring chart is output from the nonvolatile memory 120 (step S13).

The control section 110 converts the position in the main scanning direction on the sheet of the measurement data obtained in step S12 to the writing position preset in the main scanning direction on the photoconductor drum based on the size of the sheet which is the density unevenness measuring chart (step S14).

The control section 110 performs adjustment of the position in the main scanning direction based on the misalignment amount on the measurement data in which the position in the main scanning direction is converted to the writing position on the photoconductor drum (step S15).

The control section 110 performs generation processing of the correction data to correct the density unevenness based on the measurement data on which the position in the main scanning direction is adjusted in step S15 (step S16) and ends the density unevenness correction data generation processing.

The measurement data generated by the image reading section 20 or the measuring device is typically indicated with a value of a XYZ color coordinate or a RGB color coordinate.

Therefore, in step S16, first, when the measurement data is a value of the XYZ color coordinate, y curve of a CMYK color coordinate is calculated, and when the measurement data is a value of the RGB color coordinate, after the value is converted to the XYZ color coordinate, the γ curve of a CMYK color coordinate is calculated. Moreover, the average value of the density in each position in the main scanning direction is calculated with respect to each position in the sub scanning direction (in other words, with respect to each bar shaped image with the same density). Then, the correction value of each position in the main scanning direction is calculated from the γ curve with respect to each bar shaped image (with respect to each density) so as to correct the difference between the density value and the average value of each position in the main scanning direction.

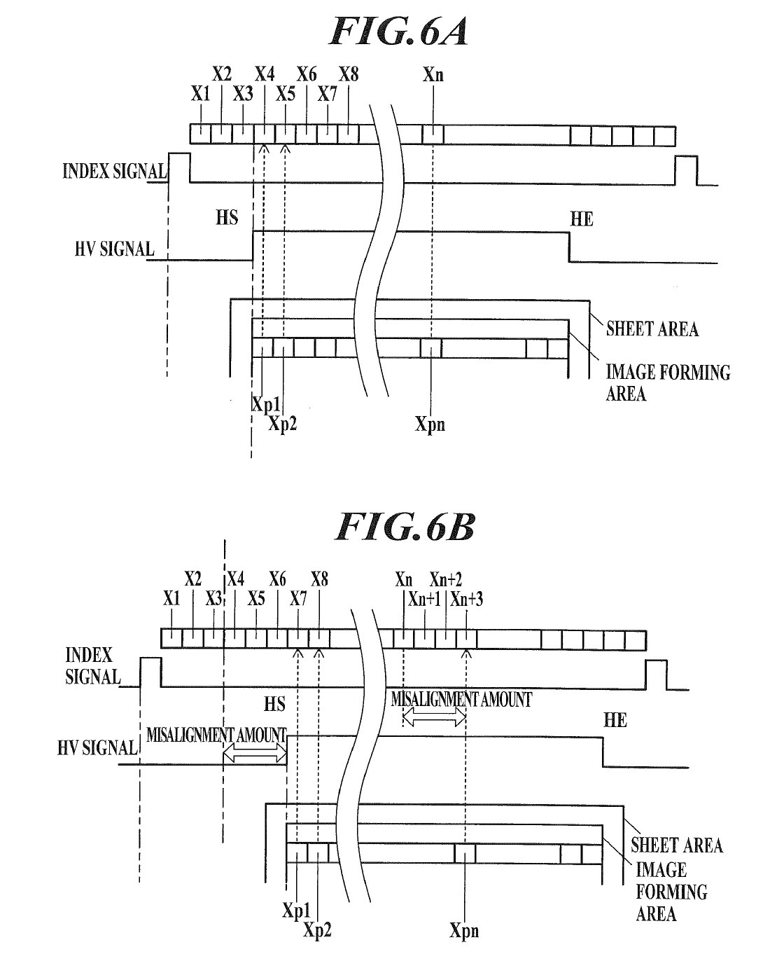

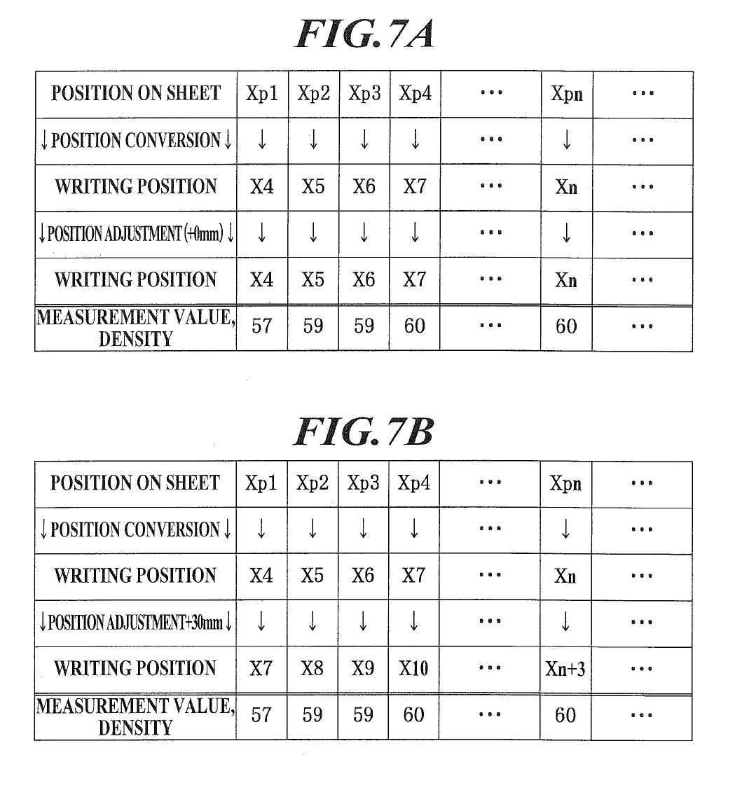

The processing in steps S14 and S15 is described using a specific example with reference to FIG. 6A, FIG. 6B, FIG. 7A and FIG. 7B.

FIG. 6A and FIG. 6B are each a diagram showing an example of a relation between a position in the main scanning direction on the sheet which is the density unevenness correction chart and the writing position in the main scanning direction on the photoconductor drum. FIG. 7A and FIG. 7B are each a diagram showing an example of transition of position in the main scanning direction of the measurement data in steps S14 and S15.

FIG. 6A shows an example when there is no misalignment of the position of the sheet in the main scanning direction and FIG. 6B shows an example when there is misalignment of the position of the sheet in the main scanning direction.

In embodiment 1, the interval (for example, distance between Xp1 and Xp2 in FIG. 6A) of the positions in the main scanning direction in the measurement data and the interval (for example, distance between X4 and X5 in FIG. 6A) of the positions of the writing position in the main scanning direction on the photoconductor drum are to be the same (for example 10 [mm]).

As shown in FIG. 6A, in embodiment 1, when there is no misalignment of the position of the sheet in the main scanning direction, the writing position Xn on the photoconductor drum and the position Xpn at the center of the sheet in the main scanning direction match at the timing of half of a main scanning writing standard term. With this condition, the time from the timing when the INDEX signal rises to the timing when the HV signal rises is set according to the length of the sheet in the main scanning direction.

As shown in FIG. 6A, when there is no misalignment of the position of the sheet in the main scanning direction, in step S14, the positions Xp1, Xp2, . . . , Xpn, . . . in the main scanning direction on the sheet of the measurement data obtained in step S12 are converted to writing positions X4, X5, . . . , Xn, . . . in the main scanning direction on the photoconductor drum set in advance based on the sheet size of the density unevenness measuring chart (see FIG. 7A).

Then, as shown in FIG. 7A, when there is no misalignment amount (for example, when the misalignment amount is 0 [mm]), in step S15, even when the misalignment amount (0 [mm]) is added to the position converted in step S14, the position in the main scanning direction of the measurement data is maintained in the position converted in step S14.

Therefore, as shown in FIG. 7A, when there is no misalignment amount, the positions Xp1, Xp2, . . . , Xpn, in the main scanning direction of the measurement data measured with the density unevenness measuring chart are writing positions X4, X5, . . . , Xn, . . . in the main scanning direction on the photoconductor drum set in advance based on sheet size.

Next, a case in which there is misalignment of the position of the sheet in the main scanning direction is described.

As shown in FIG. 6B, when there is misalignment in the position of the sheet in the main scanning direction, the writing position Xn on the photoconductor drum and the middle position Xpn at the center in the main scanning direction on the sheet do not match at the timing of half of a main scanning writing standard term. This is because due to the misalignment correction processing, the time from the timing when the INDEX signal rises to the timing when the HV signal rises is adjusted to be long (or short) compared to when there is no misalignment according to the misalignment amount.

As shown in FIG. 6B, when there is misalignment in the position on the sheet, first, in step S14, the positions Xp1, Xp2, . . . , Xpn, . . . in the main scanning direction on the sheet of the measurement data obtained in step S12 are converted to writing positions X4, X5, . . . , Xn, . . . in the main scanning direction on the photoconductor drum set in advance based on the sheet size of the density unevenness measuring chart (see FIG. 7B).

Then, as shown in FIG. 7B, when there is a misalignment amount (for example, when the misalignment amount is +30 [mm]), in step S15, the misalignment amount (+30 [mm]=3 position intervals) is added to the position converted in step S14, the position in the main scanning direction of the measurement data is moved in the amount of 3 position intervals from the position converted in step S14.

Therefore, as shown in FIG. 7B, when there is a misalignment amount, the positions Xp1, Xp2, . . . , Xpn, in the main scanning direction of the measurement data measured with the density unevenness measuring chart are to be writing positions X7, X8, . . . , Xn+3, . . . , which are writing positions X4, X5, . . . , Xn, . . . in the main scanning direction on the photoconductor drum set in advance based on sheet size moved in the misalignment amount.

When the misalignment amount is not a multiple of the position interval (for example, when the misalignment amount is 25 mm), and the position in the main scanning direction of the measurement data and the position in the main scanning direction of the correction data do not match, linear interpolation, etc. using a measurement value of the position (for example, X6.5 and X7.5) in the main scanning direction of the measurement data adjacent to the position (for example, X7) in the main scanning direction of the correction data is performed and a measurement value corresponding to each position in the main scanning direction of the correction data is calculated. Then, the correction data is generated based on the measurement value at each calculated position.

As described above, according to embodiment 1, when misalignment correction of a sheet in the main scanning direction orthogonal to the sheet conveying direction is performed, the position in the main scanning direction of the measurement data obtained from the density unevenness measuring chart output by performing the misalignment correction can be converted to the writing position in the main scanning direction on the photoconductor drum based on the misalignment amount stored in the nonvolatile memory 120 when the density unevenness measuring chart is output. Therefore, reduction of accuracy of correction of density unevenness in misalignment correction processing can be prevented.

Moreover, a density unevenness measuring chart can be output formed with a density measuring image of a length in the main scanning direction according to the length in the main scanning direction of the sheet conveyed to the image forming section 42. Therefore, measurement data which is the length in the main scanning direction of the sheet can be obtained and accuracy of the correction data can be enhanced.

Further, the position in the main scanning direction on the sheet in the measurement data is converted to the writing position in the main scanning direction on the photoconductor drum set in advance based on the sheet size of the density unevenness measuring chart, and by adding the misalignment amount to the measurement data in which the position in the main scanning direction is converted to the writing position in the main scanning direction on the photoconductor drum, adjustment of the position in the main scanning direction in the measurement data can be performed taking the misalignment amount into account.

### Embodiment 2

Embodiment 2 is described in detail with reference to the drawings.

First, the configuration is described.

The schematic configuration diagram of the image forming apparatus 1 in embodiment 2 is the same as embodiment 1, therefore the illustration is omitted and only the different portions are described.

A control section 110 in embodiment 2 reads out a misalignment correction processing program, a density unevenness measuring chart output processing program and a density unevenness correction data generation processing program, and other various necessary data from a ROM or a nonvolatile memory 120, and in coordination with the program and various data, the control section 110 performs misalignment correction processing, density unevenness measuring chart output processing and density unevenness correction data generation processing. The misalignment correction processing is similar to that of embodiment 1, and the description is omitted.

In the density unevenness measuring chart output processing in embodiment 2, a length in a main scanning direction which is a direction orthogonal to a sheet conveying direction when a sheet is conveyed on a sheet conveying path is obtained based on a sheet size of a sheet stored in a sheet feeding tray selected on an operation/display section 30. Then, density unevenness measuring image data of a length in the main scanning direction according to the obtained length in the main scanning direction is generated. Moreover, image data (misalignment amount image data) showing misalignment amount detected when the sheet on which a density measuring image is formed based on the generated density unevenness measuring image data is conveyed is generated. The latent image based on the generated density unevenness measuring image data and the misalignment amount image data is written on the photoconductor drum and the latent image is developed. Then, the sheet (density unevenness measuring chart) on which the density measuring image and the misalignment image is formed is output.

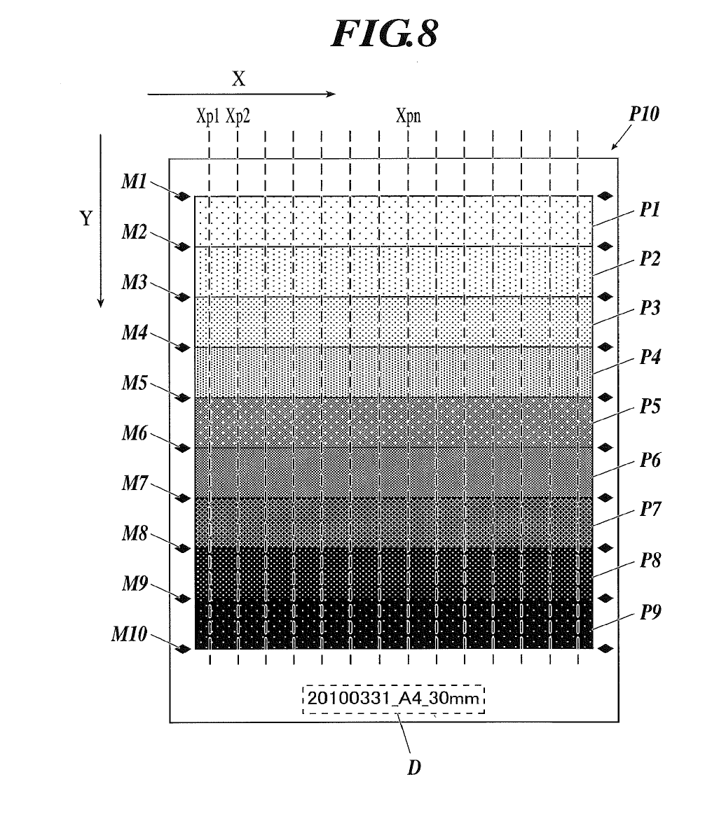

FIG. 8 is a diagram showing an example of density unevenness measuring chart in embodiment 2.

As shown in FIG. 8, the density unevenness measuring chart P10 includes density measuring images composed of a plurality of bar shaped images P1 to P9 included in the density unevenness measuring chart P0 in embodiment 1 and marks M1 to M10 showing a position of a sub scanning direction of each bar shaped image.

Similar to embodiment 1, the plurality of broken lines positioned at a certain interval in the main scanning direction X shown in FIG. 8 is a position where the density in the main scanning direction of each bar shaped image is measured by the image reading section 20 or the measuring device.

FIG. 8 shows an example of a density unevenness measuring chart which is formed by one toner color of the image forming section included in the print section 40. However, the image is not limited to this, and it is preferable to form the density measuring image for each toner color included in the image forming section.

Moreover, the density unevenness measuring chart in embodiment 2 includes a misalignment amount image D. The misalignment amount image D is an image indicating the misalignment amount when the sheet which is to be the density unevenness measuring chart is conveyed. Further, the alignment amount image D can include an image indicating date and time information of when the density unevenness measuring chart is output, sheet size, type of screen, etc.

For example, when the date of when the density unevenness measuring chart is output is Mar. 31, 2010, the sheet size is A4, and the misalignment amount is 30 mm, an image of “20100331_A4_{—}30 mm” is formed as the misalignment amount image D.

In the density unevenness correction data generation processing in embodiment 2, measurement data indicating density of each position in the main scanning direction of each bar shaped image in the density measuring image formed on the density unevenness measuring chart is obtained from the image reading section or the measuring device and input of the misalignment amount indicated by the misalignment amount image formed on the density unevenness measuring chart is received by the operation/display section 30.

Then, a position in the main scanning direction on a sheet in the measurement data is converted to a writing position in the main scanning direction on a photoconductor drum according to the misalignment amount input from the operation/display section 30. Then, correction data to correct density unevenness in the main scanning direction is generated based on the measurement data in which the position in the main scanning direction is converted.

The operation/display section 30 is composed from a display section including a LCD (Liquid Crystal Display), etc. and a touch panel 31 provided covering the LCD, and as other components, an input section such as operation keys, and an operation/display control section which are not shown. The operation/display section 30 outputs an operation signal input from a touch panel 31 or input section such as operation keys to the control section 110. Moreover, the operation/display section 30 displays various screens to input various setting conditions, various processing results, etc. on the display section according to a display signal input from the control section 110 by the operation/display control section.

Moreover, the operation/display section 30 functions as an input section to receive input of misalignment amount indicated by the misalignment amount image formed in the correction unevenness measuring chart.

Next, the operation of embodiment 2 is described.

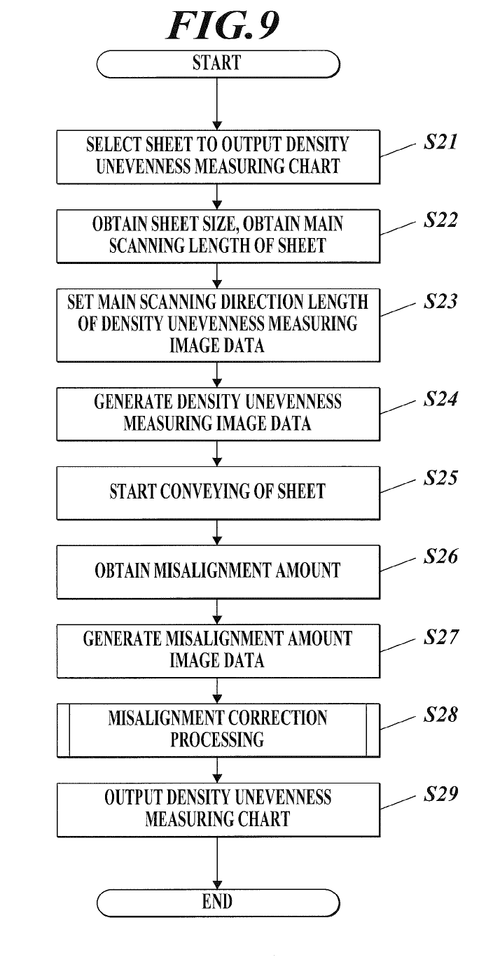

FIG. 9 is a flowchart showing a density unevenness measuring chart output processing in embodiment 2. The flowchart shown in FIG. 9 is a processing performed by the control section 110 in coordination with each section.

Steps S21 to S26 are similar to steps S1 to S6 shown in FIG. 4 of embodiment 1, and therefore the description is omitted.

The control section 110 generates image data (misalignment amount image data) indicating the misalignment amount based on the misalignment amount obtained in step S26 (step S27).

Step S28 is similar to step S8 shown in FIG. 4 of embodiment 1, and therefore the description is omitted.

According to an HV signal, etc., the control section 110 forms the density measuring image based on the density unevenness measuring image data and the misalignment amount image based on the misalignment amount image data onto the sheet and outputs the density unevenness measuring chart from the print section 40 (step S29) and ends the density unevenness measuring chart output processing.

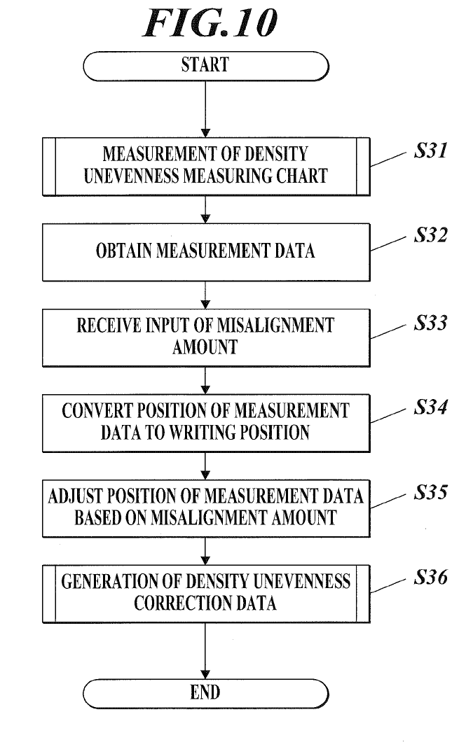

FIG. 10 is a flowchart indicating the density unevenness correction data generation processing in embodiment 2. The flowchart shown in FIG. 10 is a processing performed by the control section 110 in coordination with each section.

Steps S31 and S32 are similar to steps S11 and S12 shown in FIG. 5 of embodiment 1, and therefore the description is omitted.

The misalignment amount image formed on the density unevenness measuring chart is referred to by the user, the user operates the operation/display section 30 to input the misalignment amount indicated by the misalignment amount image and the control section 110 receives input of the misalignment amount from the operation/display section 30 (step S33).

Steps S34 to S36 are similar to steps S14 to S16 shown in FIG. 5 of embodiment 1, and therefore the description is omitted.

As described above, according to embodiment 2, when misalignment correction of a sheet in the main scanning direction orthogonal to the sheet conveying direction is performed, the position in the main scanning direction of the measurement data obtained from the density unevenness measuring chart output by performing the misalignment correction can be converted to the writing position in the main scanning direction on the photoconductor drum based on the misalignment amount indicated by the misalignment amount image formed on the density unevenness measuring chart. Therefore, reduction of accuracy of correction of density unevenness in misalignment correction processing can be prevented.

Moreover, similar to embodiment 1, a density unevenness measuring chart can be output formed with a density measuring image of a length in the main scanning direction according to the length in the main scanning direction of the sheet conveyed to the image forming section 42. Therefore, measurement data with the length in the main scanning direction of the sheet can be obtained and accuracy of the correction data can be enhanced.

Further, the position in the main scanning direction on the sheet in the measurement data is converted to the writing position in the main scanning direction on the photoconductor drum set in advance based on the sheet size of the density unevenness measuring chart, and by adding the misalignment amount to the measurement data in which the position in the main scanning direction is converted to the writing position in the main scanning direction on the photoconductor drum, adjustment of the position in the main scanning direction in the measurement data can be performed taking the misalignment amount into account.

The above description discloses an example using a nonvolatile memory 120 as a computer readable medium of the program of the present invention, however, the invention is not limited to this example.

As other computer readable media, a nonvolatile memory such as a flash memory, a portable recording medium such as a CD-ROM, etc. and the like can be applied.

Moreover, as a medium to provide data of the program of the present invention through communication lines, a carrier wave can be employed in the present invention.

The present invention is not limited to the content of the above embodiment 1 and 2 and can be changed accordingly without leaving the scope of the present invention.

According to an aspect of the preferred embodiments of the present invention, there is provided an image forming apparatus including:

an image forming section to write a latent image based on image data on an image carrier extending in a main scanning direction which is a direction orthogonal to a conveying direction of a sheet, and to develop the latent image to form an image on a sheet;

a misalignment detecting section to detect misalignment amount of a sheet in the main scanning direction on a sheet conveying path to the image forming section;

a storage section to store the misalignment amount detected by the misalignment detecting section;

a density measuring section to measure density of a plurality of preset positions in the main scanning direction of the image formed on the sheet and to generate measurement data; and

a control section
to adjust a writing position in the main scanning direction on the image carrier of the latent image based on the misalignment amount;
to allow the image forming section to write on the image carrier the latent image based on image data in which density is the same in the main scanning direction and to develop the latent image to output the sheet on which a density measuring image is formed; and
to convert the position in the main scanning direction on the sheet of the measurement data obtained from the density measuring section to the writing position in the main scanning direction on the image carrier according to the misalignment amount stored in the storage section and to generate correction data to correct density unevenness in the main scanning direction based on measurement data in which the position in the main scanning direction is converted; and

a density unevenness correcting section to correct the density of the image formed by the image forming section based on the correction data generated by the control section.

According to another aspect of the preferred embodiments of the present invention, there is provided a density unevenness correction method including:

misalignment detecting to detect misalignment amount of a sheet in a main scanning direction which is a direction orthogonal to a sheet conveying direction on a sheet conveying path;

storing to store the detected misalignment amount in a storage section;

sheet outputting to write a latent image based on image data with a same density in the main scanning direction on an image carrier extending in the main scanning direction and to develop the latent image to output a sheet on which a density measuring image is formed;

misalignment amount correcting to adjust a writing position of the latent image in the main scanning direction on the image carrier based on the misalignment amount;

density measuring to measure density in a plurality of preset positions in the main scanning direction of the density measuring image formed on the sheet to generate measurement data;

correction data generating to convert the position in the main scanning direction on the sheet of the measurement data generated in the density measuring step to the writing position in the main scanning direction on the image carrier according to the misalignment amount stored in the storage section and to generate correction data to correct density unevenness in the main scanning direction based on the measurement data on which the position in the main scanning direction is converted; and

density unevenness correcting to correct density of an image formed on the sheet based on the generated correction data.

Consequently, in the above image forming apparatus, when misalignment correction of a sheet in the main scanning direction orthogonal to the sheet conveying direction is performed, the position of the measurement data obtained from the sheet on which the density measuring image, in which the writing position in the main scanning direction is adjusted based on the misalignment amount, is formed can be converted to the writing position on the image carrier according to the misalignment amount stored in the storage section. Therefore, reduction of accuracy of correction of density unevenness can be prevented.

According to another aspect of the preferred embodiments of the present invention, there is provided an image forming apparatus including:

an image forming section to write a latent image based on image data on an image carrier extending in a main scanning direction which is a direction orthogonal to a conveying direction of a sheet, and to develop the latent image to form an image on a sheet which is output;

a misalignment detecting section to detect misalignment amount of a sheet in the main scanning direction on a sheet conveying path to the image forming section;

a density measuring section to measure density of a plurality of preset positions in the main scanning direction of the image formed on the sheet and to generate measurement data;

an input section to receive input of the misalignment amount; and

a control section
to adjust a writing position in the main scanning direction on the image carrier of the latent image based on the misalignment amount;
to allow the image forming section to write on the image carrier the latent image based on image data in which density is the same in the main scanning direction and image data indicating the misalignment amount and to develop the latent image to output the sheet on which a density measuring image and a misalignment amount image is formed;
to receive input of the misalignment amount indicated by the misalignment amount image formed on the sheet from the input section;
to convert the position in the main scanning direction on the sheet of the measurement data obtained from the density measuring section to the writing position in the main scanning direction on the image carrier according to the misalignment amount received from the input section and to generate correction data to correct density unevenness in the main scanning direction based on measurement data in which the position in the main scanning direction is converted; and
a density unevenness correcting section to correct the density of the image formed by the image forming section based on the correction data generated by the control section.

According to another aspect of the preferred embodiments of the present invention, there is provided a density unevenness correction method including:

misalignment detecting to detect a misalignment amount of a sheet in a main scanning direction which is a direction orthogonal to a sheet conveying direction on a sheet conveying path;

sheet outputting to write a latent image based on image data with a same density in the main scanning direction and image data indicating the misalignment amount on an image carrier extending in the main scanning direction and to develop the latent image to output a sheet on which a density measuring image and a misalignment amount image is formed;

misalignment amount correcting to adjust a writing position of the latent image in the main scanning direction on the image carrier based on the misalignment amount;

density measuring to measure density in a plurality of preset positions in the main scanning direction of the density measuring image formed on the sheet to generate measurement data;

inputting to receive input of a misalignment amount indicated by the misalignment amount image formed on the sheet;

correction data generating to convert the position in the main scanning direction on the sheet of the measurement data generated in the density measuring step to the writing position in the main scanning direction on the image carrier according to the misalignment amount received in the inputting step and to generate correction data to correct density unevenness in the main scanning direction based on the measurement data on which the position in the main scanning direction is converted; and

density unevenness correcting to correct density of an image formed on the sheet based on the generated correction data.

Consequently, in the image forming apparatus, when misalignment correction of a sheet in the main scanning direction orthogonal to the sheet conveying direction is performed, the position of the measurement data obtained from the sheet on which the density measuring image, in which the writing position in the main scanning direction is adjusted based on the misalignment amount, is formed can be converted to the writing position on the image carrier according to the misalignment amount indicated by the misalignment amount image formed on the sheet with the density measuring image. Therefore, reduction of accuracy of correction of density unevenness can be prevented.

Preferably, in the image forming apparatus, the control section changes a length in the main scanning direction of the image data to form the density measuring image according to a length in the main scanning direction of the sheet conveyed to the image forming section.

Consequently, a sheet on which a density measuring image of a length in the main scanning direction according to the length in the main scanning direction of the sheet conveyed to the image forming section is formed can be output. Therefore, measurement data with the length in the main scanning direction of the sheet can be obtained and accuracy of the correction data can be enhanced.

Preferably, in the image forming apparatus, the control section:

converts the position in the main scanning direction on the sheet of the measurement data to the writing position in the main scanning direction on the image carrier set in advance based on the sheet size; and

performs adjustment of position of the measurement data according to the misalignment amount on the measurement data in which the position in the main scanning direction is converted to the writing position on the image carrier.

Consequently, the position in the main scanning direction on the sheet in the measurement data is converted to the writing position in the main scanning direction on the image carrier set in advance based on the sheet size of the sheet, and adjustment of the writing position according to the misalignment amount can be performed on the measurement data in which the position of the main scanning direction is converted to the writing position on the image carrier.

Although various exemplary embodiments have been shown and described, the invention is not limited to the embodiments shown. Therefore, the scope of the invention is intended to be limited solely by the scope of the claims that follow and not by the above explanation, and it is intended that the present invention covers modifications and variations that come within the scope of the appended claims and their equivalents.

The present application is based on Japanese Patent Application No. 2010-053905 filed on Mar. 11, 2010 to the Japanese Patent Office, which shall be a basis for correcting mistranslations.

What is claimed is:

1. An image forming apparatus comprising:
an image forming section to write a latent image based on image data on an image carrier extending in a main scanning direction which is a direction orthogonal to a conveying direction of a sheet, and to develop the latent image to form an image on a sheet;
a misalignment detecting section to detect misalignment amount of a sheet in the main scanning direction on a sheet conveying path to the image forming section;
a storage section to store the misalignment amount detected by the misalignment detecting section;
a density measuring section to measure density of a plurality of preset positions in the main scanning direction of the image formed on the sheet and to generate measurement data; and
a control section
to adjust a writing position in the main scanning direction on the image carrier of the latent image based on the misalignment amount;
to allow the image forming section to write on the image carrier the latent image based on image data in which density is the same in the main scanning direction and to develop the latent image to output the sheet on which a density measuring image is formed; and
to convert the position in the main scanning direction on the sheet of the measurement data obtained from the density measuring section to the writing position in the main scanning direction on the image carrier according to the misalignment amount stored in the storage section and to generate correction data to correct density unevenness in the main scanning direction based on measurement data in which the position in the main scanning direction is converted; and
a density unevenness correcting section to correct the density of the image formed by the image forming section based on the correction data generated by the control section.

2. An image forming apparatus comprising:
an image forming section to write a latent image based on image data on an image carrier extending in a main scanning direction which is a direction orthogonal to a conveying direction of a sheet, and to develop the latent image to form an image on a sheet which is output;
a misalignment detecting section to detect misalignment amount of a sheet in the main scanning direction on a sheet conveying path to the image forming section;
a density measuring section to measure density of a plurality of preset positions in the main scanning direction of the image formed on the sheet and to generate measurement data;
an input section to receive input of the misalignment amount; and
a control section
to adjust a writing position in the main scanning direction on the image carrier of the latent image based on the misalignment amount;
to allow the image forming section to write on the image carrier the latent image based on image data in which density is the same in the main scanning direction and image data indicating the misalignment amount and to develop the latent image to output the sheet on which a density measuring image and a misalignment amount image is formed;
to receive input of the misalignment amount indicated by the misalignment amount image formed on the sheet from the input section;
to convert the position in the main scanning direction on the sheet of the measurement data obtained from the density measuring section to the writing position in the main scanning direction on the image carrier according to the misalignment amount received from the input section and to generate correction data to correct density unevenness in the main scanning direction based on measurement data in which the position in the main scanning direction is converted; and
a density unevenness correcting section to correct the density of the image formed by the image forming section based on the correction data generated by the control section.

3. The image forming apparatus of claim 1 wherein the control section changes a length in the main scanning direction of the image data to form the density measuring image according to a length in the main scanning direction of the sheet conveyed to the image forming section.

4. The image forming apparatus of claim 2 wherein the control section changes a length in the main scanning direction of the image data to form the density measuring image according to a length in the main scanning direction of the sheet conveyed to the image forming section.

5. The image forming apparatus of claim 1 wherein the control section:
converts the position in the main scanning direction on the sheet of the measurement data to the writing position in the main scanning direction on the image carrier set in advance based on the sheet size; and
performs adjustment of position of the measurement data according to the misalignment amount on the measurement data in which the position in the main scanning direction is converted to the writing position on the image carrier.

6. The image forming apparatus of claim 2 wherein the control section:
converts the position in the main scanning direction on the sheet of the measurement data to the writing position in the main scanning direction on the image carrier set in advance based on the sheet size; and
performs adjustment of position of the measurement data according to the misalignment amount on the measurement data in which the position in the main scanning direction is converted to the writing position on the image carrier.

7. A density unevenness correction method comprising:
misalignment detecting to detect misalignment amount of a sheet in a main scanning direction which is a direction orthogonal to a sheet conveying direction on a sheet conveying path;
storing to store the detected misalignment amount in a storage section;
sheet outputting to write a latent image based on image data with a same density in the main scanning direction on an image carrier extending in the main scanning direction and to develop the latent image to output a sheet on which a density measuring image is formed;
misalignment amount correcting to adjust a writing position of the latent image in the main scanning direction on the image carrier based on the misalignment amount;
density measuring to measure density in a plurality of preset positions in the main scanning direction of the density measuring image formed on the sheet to generate measurement data;
correction data generating to convert the position in the main scanning direction on the sheet of the measurement data generated in the density measuring step to the writing position in the main scanning direction on the image carrier according to the misalignment amount stored in the storage section and to generate correction data to correct density unevenness in the main scanning direction based on the measurement data on which the position in the main scanning direction is converted; and
density unevenness correcting to correct density of an image formed on the sheet based on the generated correction data.

8. A density unevenness correction method comprising:
misalignment detecting to detect a misalignment amount of a sheet in a main scanning direction which is a direction orthogonal to a sheet conveying direction on a sheet conveying path;
sheet outputting to write a latent image based on image data with a same density in the main scanning direction and image data indicating the misalignment amount on an image carrier extending in the main scanning direction and to develop the latent image to output a sheet on which a density measuring image and a misalignment amount image is formed;
misalignment amount correcting to adjust a writing position of the latent image in the main scanning direction on the image carrier based on the misalignment amount;
density measuring to measure density in a plurality of preset positions in the main scanning direction of the density measuring image formed on the sheet to generate measurement data;
inputting to receive input of a misalignment amount indicated by the misalignment amount image formed on the sheet;
correction data generating to convert the position in the main scanning direction on the sheet of the measurement data generated in the density measuring step to the writing position in the main scanning direction on the image carrier according to the misalignment amount received in the inputting step and to generate correction data to correct density unevenness in the main scanning direction based on the measurement data on which the position in the main scanning direction is converted; and
density unevenness correcting to correct density of an image formed on the sheet based on the generated correction data.
